(19) United States
(12) Patent Application Publication
(10) Pub. No.: US 2007/0276771 A1
(43) Pub. Date: Nov. 29, 2007

(54) Phone Line Testing To Determine Modem License Fee

(76) Inventor: Timothy William Saeger, Carmel, IN (US)

Correspondence Address: JOSEPH J. LAKS, VICE PRESIDENT;THOMSON LICENSING LLC, PATENT OPERATIONS, PO BOX 5312, PRINCETON, NJ, 08543-5312, US

(21) Appl. No.: 11/547,428

(22) PCT Filed: Jun. 8, 2004
(86) PCT No.: PCT/US04/18101

§ 371 Date: Sep. 29, 2006

Related U.S. Application Data
(60) Provisional application No. 60/557,472, filed on Mar. 30, 2004.

(51) Int. Cl. G06F 19/00

(52) U.S. Cl. 705/412

(57) ABSTRACT

There is provided, in a Set Top Box (STB) having a licensed modem and being connected to a network head-end through a phone line, a method for providing licensing fee information for the modem. A communications test is performed to determine a maximum communication speed at which the modem can be operated in a current configuration. The maximum communication speed determined by the communications test is forwarded to a remote entity for use in determining the licensing fee for the modem.

This application claims the benefit, under 35 U.S.C. §365 of International Application PCT/US2004/18101, filed Jun. 8, 2004, which was published in accordance with PCT Article 21(2) on Nov. 3, 2005 in English and which claims the benefit of United States provisional patent application No. 60/557,472 filed Mar. 30, 2004.

### BACKGROUND OF THE INVENTION

1. Field of the Invention

The present invention generally relates to phone lines and modems and, more particularly, to testing a phone line and corresponding equipment and conditions to determine the actual maximum speed at which a licensed modem may be operated when connected to the phone line, so that the modem licensing fee can be adjusted accordingly.

2. Background of the Invention

For modems that are licensed for use, the licensing costs for such modems typically vary significantly based on the communication rate (also referred to herein as “communication speed”). That is, a higher communication rate typically means a higher licensing rate.

Conventionally, in a connection between a Set Top Box (STB) and a network head-end that involves a modem, the modem is connected at the fastest transmission speed the modem is capable of and, if the network does not support that transmission speed, the transmission speed is reduced accordingly. However, since the modem includes the capability to operate at the fastest transmission speed (even if that top speed is not utilized due to, e.g., network constraints), the higher license fee must be paid.

Accordingly, it would be desirable and highly advantageous to have a method and apparatus for testing a phone line to determine the actual maximum speed at which the modem may be operated when connected to the phone line, so that the modem licensing fee can be adjusted accordingly.

### SUMMARY OF THE INVENTION

The problems stated above, as well as other related problems of the prior art, are solved by the present invention, which is directed to a method and apparatus for testing a phone line and corresponding equipment and conditions to determine the actual maximum speed at which a licensed modem may be operated when connected to the phone line, so that the modem licensing fee can be adjusted accordingly. The phone line may be used to connect a network head-end to a Set Top Box (STB) that includes the modem

According to an aspect of the present invention, there is provided, in a Set Top Box (STB) having a licensed modem and being connected to a network head-end through a phone line, a method for providing licensing fee information for the modem. A communications test is performed to determine a maximum communication speed at which the modem can be operated in a current configuration. The maximum communication speed determined by the communications test is forwarded to a remote entity for use in determining the licensing fee for the modem.

According to another aspect of the present invention, there is provided, in a Set Top Box (STB) having a licensed modem and being adapted for connection to a network head-end through a phone line, a test module for providing licensing fee information for the modem. The test module includes means for performing a communications test to determine a maximum communication speed at which the modem can be operated in a current configuration. The test module further includes means for outputting the actual communication speed for subsequent use by a remote entity in determining the licensing fee for the modem.

According to yet another aspect of the present invention, there is provided, in a Set Top Box (STB) having a licensed modem and being connected to a network head-end through a phone line, a method for providing licensing fee information for the modem. A communications test is performed to determine a maximum communication speed at which the modem can be operated in a current configuration. At least one of the maximum communication speed determined by the communications test and information related thereto are forwarded to a remote entity for use in at least one of determining the licensing fee for the modem and managing a licensing of the modem.

These and other aspects, features and advantages of the present invention will become apparent from the following detailed description of preferred embodiments, which is to be read in connection with the accompanying drawings.

### BRIEF DESCRIPTION OF THE DRAWINGS

FIG. 1 is a diagram illustrating a communication architecture 100 to which the present invention may be applied, according to an illustrative embodiment of the present invention; and

FIG. 2 is a diagram illustrating a method for determining licensing fee information for a licensed modem included in a Set Top Box (STB) that is connected to a network head-end through a phone line, according to an illustrative embodiment of the present invention.

### DETAILED DESCRIPTION OF THE INVENTION

The present invention is directed to a method and apparatus for testing a phone line and corresponding equipment and conditions to determine the actual maximum speed at which a licensed modem may be operated when connected to the phone line, so that the modem licensing fee can be adjusted accordingly. The phone line may be used to connect a network head-end to a Set Top Box (STB) that includes the modem.

It is to be understood that the present invention may be implemented in various forms of hardware, software, firmware, special purpose processors, or a combination thereof. Preferably, the present invention is implemented as a combination of hardware and software. Moreover, the software is preferably implemented as an application program tangibly embodied on a program storage device. The application program may be uploaded to, and executed by, a machine comprising any suitable architecture. Preferably, the machine is implemented on a computer platform having hardware such as one or more central processing units (CPU), a random access memory (RAM), and input/output (I/O) interface(s). The computer platform also includes an operating system and microinstruction code. The various processes and functions described herein may either be part of the microinstruction code or part of the application program (or a combination thereof) that is executed via the operating system. In addition, various other peripheral devices may be connected to the computer platform such as an additional data storage device and a printing device.

It is to be further understood that, because some of the constituent system components and method steps depicted in the accompanying Figures are preferably implemented in software, the actual connections between the system components (or the process steps) may differ depending upon the manner in which the present invention is programmed. Given the teachings herein, one of ordinary skill in the related art will be able to contemplate these and similar implementations or configurations of the present invention.

A Set Top Box (STB) when shipped would include a modem with hardware that allowed a connection up to v.90 (56 kbps). However, the software shipped with the STB would only enable a much lower speed communication (14.4 kbps). It is to be appreciated that while v.90 (56 kbps) is the current maximum communication speed for a dialup modem, the present invention is not so limited and may be applied to greater speeds (>56 bps) as they become available, while maintaining the spirit of the present invention.

A test program can then be used to determine if it is possible to actually connect to the network at a higher modem speed. Some of the issues that could affect connection speed include, but are not limited to, in-home wiring, and type of modems used in at the head-end, and so forth.

The test program could include any number of options including, but not limited to, dialing the head-end multiple times, and characterizing the highest possible transmission rate. Once this was determined, the modem would be enabled for only the highest speed possible (or likely) to actually be used in the network, for this particular subscriber.

This enables a subscriber-end selection of the highest modem speed possible, optimizing (minimizing) the licensing costs, rather than enabling all modems for the highest speed connection.

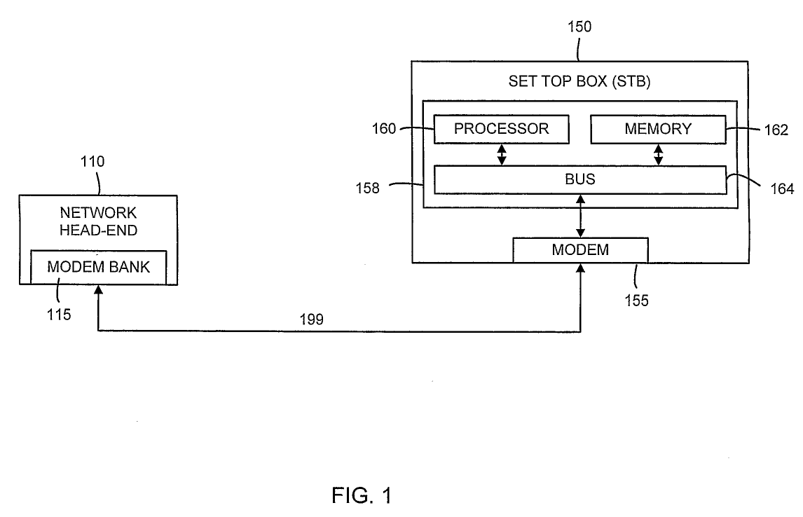

FIG. 1 is a diagram illustrating a communication architecture 100 to which the present invention may be applied, according to an illustrative embodiment of the present invention.

The communication architecture 100 includes a network head end 110 coupled to a Set Top Box (STB) 150 via a phone line 199.

The network head-end 110 includes a modem bank 115. The STB 150 includes a modem 155 and a test module 158. The maximum communication speed at which the modem 155 can be operated in a current configuration (e.g., given existing communication conditions) is determined by the test module 158, for subsequent use by a remote entity in determining, setting, maintaining, managing, enforcing, and so forth (hereinafter collectively referred to as “determining”) the licensing fee for the modem 155. The remote entity may be any entity outside of the STB that can use the maximum communication speed and/or information corresponding thereto for a purpose relating to the licensing fee for the modem (e.g., “determining” the licensing fee).

The test module 158 includes a processor 160, a memory device 162, and a bus 164 for connecting the processor 160 to the memory device 162 and for connecting the test module 158 to the modem 155. The test module 158 analyzes, for example, the communications in which the modem 155 is involved and related conditions (e.g., line conditions, network conditions, and so forth), to ascertain the maximum communication speed at which the modem 155 can be operated in its current configuration.

It is to be appreciated that while the test module 158 is shown and described as a separate and distinct entity within the STB 150, in other embodiments of the present invention one or more of the elements of the test module 158 may be already included in the STB 150 or in the modem 155 within the STB 150 thus obviating the need for duplication of such elements in the test module 158.

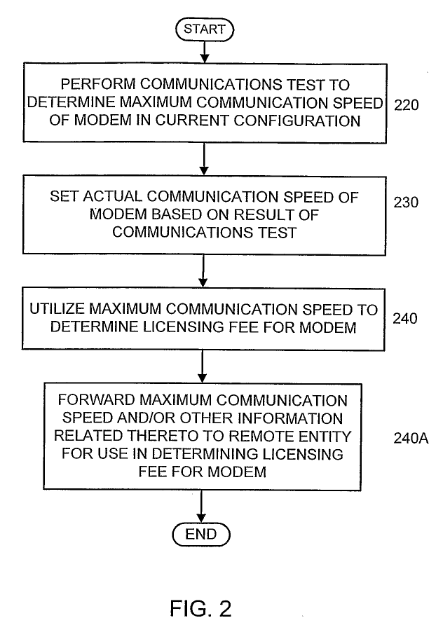

FIG. 2 is a diagram illustrating a method for determining licensing fee information for a licensed modem included in a Set Top Box (STB) that is connected to a network head-end through a phone line, according to an illustrative embodiment of the present invention.

A communications test is performed to determine the maximum communication speed at which the modem can be operated in a current configuration (step 220). The communications test may involve, but is not limited to, dialing the head-end multiple times and characterizing the highest possible connection/transmission rate. It is to be appreciated that communications testing with respect to the current configuration of the modem involves determining and/or analyzing existing communication conditions including, but not limited to, phone line conditions, wiring type (e.g., in-house, etc.), and modem types both at the set top box and at the network head-end.

The actual communication speed of the modem is then set based upon a result of the communications test (step 230). That is, the actual communication speed of the modem is set to the maximum communication speed determined by the communications test.

The maximum communication speed determined by the communications test is utilized to determine the licensing fee for the modem (step 240). Step 240 may involve, for example, forwarding the communication speed and/or other information related thereto to a remote entity for use in determining the licensing fee (step 240A). It is to be appreciated that the test module 158 may include a loop-up table in, e.g., the memory device 162 so that the test module can itself determine the licensing fee and forward this fee to a remote entity for management and enforcement thereof. Of course, in some cases, updating of the look-up table may need to be performed. Given the teachings of the present invention provided herein, these and other variations of the steps and hardware shown herein are readily contemplated and implemented by one of ordinary skill in the related art, while maintaining the spirit and scope of the present invention.

Although the illustrative embodiments have been described herein with reference to the accompanying drawings, it is to be understood that the present invention is not limited to those precise embodiments, and that various other changes and modifications may be affected therein by one of ordinary skill in the related art without departing from the scope or spirit of the invention. All such changes and modifications are intended to be included within the scope of the invention as defined by the appended claims.

1. A method for providing licensing fee information for communication device comprising the steps of:
performing a communications test to determine a maximum communication speed at which a communication device can be operated; and
forwarding the maximum communication speed determined by the communications test to a remote entity for use in determining the licensing fee for the communication device.

2. The method of claim 1, wherein said step of performing the communications test comprises the steps of:
dialing the network head-end multiple times; and
characterizing a highest possible transmission rate based on at least a result of said dialing step.

3. The method of claim 1, further comprising the step of setting a configurable communication speed of the communication device to the maximum communication speed determined by the communications test.

4. The method of claim 1, wherein said communication test is adapted to evaluate phone line conditions and network conditions.

5. The method of claim 4, wherein the phone line conditions include wiring type.

6. The method of claim 4, wherein the network conditions include a type of another modem at the network head-end to which the modem is connected through the phone line.

7. The method of claim 1, wherein the maximum communication speed determined by the communications test is less than a highest communication speed at which the communication device is capable of communicating.

8. An apparatus for providing licensing fee information for a communication device comprising:
means for performing a communications test to determine a maximum communication speed at which the communication device can be operated; and
means for outputting the actual communication speed for subsequent use by a remote entity in determining the licensing fee for the communication device.

9. The test module of claim 8, wherein said means for performing comprises means for characterizing a highest possible transmission rate, based on multiple dialings to the network head-end.

10. The test module of claim 8, wherein the existing communication conditions include phone line conditions, wiring type, and a type of another communication device at the network head-end to which the modem is connected.

11. The test module of claim 8, wherein the test module is comprised within a set top box.

12. The test module of claim 8, wherein the test module is comprised within a modem.

13. The test module of claim 12, further comprising means for forwarding the actual communication speed determined by the communication test to the remote entity for use in determining the licensing fee for a modem as the communication device.

14. In a Set Top Box (STB) having a licensed modem and being connected to a network head-end through a phone line, a method for providing licensing fee information for the modem, the method comprising the steps of:
performing a communications test to determine a maximum communication speed at which the modem can be operated in a current configuration; and
forwarding at least one of the maximum communication speed determined by the communications test and information related thereto to a remote entity for use in at least one of determining the licensing fee for the modem and managing a licensing of the modem.

15. The method of claim 14, wherein said step of performing the communications test comprises the steps of:
dialing the network head-end multiple times; and
characterizing a highest possible transmission rate based on at least a result of said dialing step.

16. The method of claim 14, further comprising the step of setting a configurable communication speed of the modem to the maximum communication speed determined by the communications test.

17. The method of claim 14, wherein said communication test is adapted to evaluate phone line conditions and network conditions.

18. The method of claim 14, wherein the phone line conditions include wiring type.

19. The method of claim 14, wherein the network conditions include a type of another modem at the network head-end to which the modem is connected through the phone line.

20. The method of claim 14, wherein the maximum communication speed determined by the communications test is less than a highest communication speed at which the modem is capable of communicating.

21. A method comprising the steps of:
Initiating a communications test to determine a maximum communication speed at which a communication device can be operated; and
receiving the maximum communication speed determined by the communications test for determining the licensing fee for the communication device.

22. The method of claim 21, wherein said communication test is adapted to evaluate phone line conditions and network conditions.
